(19) United States
(12) Patent Application Publication
(10) Pub. No.: US 2022/0122430 A1
(43) Pub. Date: Apr. 21, 2022

(54) REGISTER MACHINE FOR A CHECKOUT SYSTEM

(71) Applicant: TOSHIBA TEC KABUSHIKI KAISHA, Tokyo (JP)

(72) Inventor: Takahiro SHIMURA, Gotemba Shizuoka (JP)

(21) Appl. No.: 17/565,084

(22) Filed: Dec. 29, 2021

Related U.S. Application Data
(63) Continuation of application No. 16/892,021, filed on Jun. 3, 2020.
Application No. 16/892,021 is a continuation of application No. 15/857,293, filed on Dec. 28, 2017, now abandoned.

(30) Foreign Application Priority Data
Feb. 9, 2017 (JP) 2017-022500

(51) Int. Cl. G07G 1/00; G07G 1/01; G07G 1/14; G06Q 20/20

(52) U.S. Cl. CPC G07G 1/0009; G07G 1/01; G06Q 20/202; G07G 1/14; G07G 1/0036

(57) ABSTRACT

A register machine of a register machine network including the register machine and a plurality of other register machines, comprises a network communication interface through data are transmitted to and received from the other register machines, a display device, an input device, and a control unit. The control unit is configured to control the network communication interface to receive, from a registration apparatus, product registration information generated by the registration apparatus, execute checkout processing for the received product registration information, determine whether an abnormality occurs in the register machine that prevents completion of the checkout processing, when the abnormality is determined to occur, control the display device to display a register machine selection screen that displays the other register machines, at least one of which is selectable, receive, via the input device, an input selecting one of the other register machines, and control the network communication interface to cause the product registration information to be transmitted to the selected one of the other register machines.

### CROSS-REFERENCE TO RELATED APPLICATIONS

This application is a continuation of U.S. patent application Ser. No. 16/892,021, filed on Jun. 3, 2020, which is a continuation of U.S. patent application Ser. No. 15/857,293, filed on Dec. 28, 2017, now abandoned, which application is based upon and claims the benefit of priority from Japanese Patent Application No. 2017-022500, filed on Feb. 9, 2017, the entire contents of each of which are incorporated herein by reference.

### FIELD

Embodiments described herein relate generally to a register machine for a checkout system.

### BACKGROUND

In a semi-self-service checkout system, a store clerk performs sales registration of commodities with a registration apparatus and a customer personally performs accounting processing for purchase of the commodities with an accounting apparatus.

In such a semi-self-service checkout system, if an abnormality such as a failure of the accounting apparatus occurs, the customer calls the store clerk and requests the store clerk to solve the abnormality. The customer performs the accounting processing after the store clerk solves the abnormality. Therefore, the customer has to wait until the abnormality is solved.

### BRIEF DESCRIPTION OF THE DRAWINGS

FIG. 1 is a schematic diagram showing an example of a semi-self-service checkout system according to an embodiment;

FIG. 2 is a perspective view showing an example exterior of a registration apparatus;

FIG. 3 is a perspective view showing an example exterior of an accounting apparatus;

FIG. 4 is a block diagram showing an example hardware configuration of the registration apparatus;

FIG. 5 is a block diagram showing an example hardware configuration of the accounting apparatus;

FIG. 6 is a block diagram showing an example functional configuration of the semi-self-service checkout system;

FIG. 7 is a diagram showing an example of a transfer configuration screen;

FIG. 8 is a diagram showing an example of an apparatus selection screen;

FIG. 9 is a diagram showing an example of a transfer completion screen; and

FIG. 10 is a flowchart illustrating an example of transfer processing.

### DETAILED DESCRIPTION

Embodiments provide a register machine network including a plurality of register machines that are networked together and cooperate with each other to accelerate checkout processing by the register machines and improve convenience of customers.

In general, according to one embodiment, a register machine of a register machine network including the register machine and a plurality of other register machines, comprises a network communication interface through data are transmitted to and received from the other register machines, a display device, an input device, and a control unit. The control unit is configured to control the network communication interface to receive, from a registration apparatus, product registration information generated by the registration apparatus, execute checkout processing for the received product registration information, determine whether an abnormality occurs in the register machine that prevents completion of the checkout processing, when the abnormality is determined to occur, control the display device to display a register machine selection screen that displays the other register machines, at least one of which is selectable, receive, via the input device, an input selecting one of the other register machines, and control the network communication interface to cause the product registration information to be transmitted to the selected one of the other register machines.

A register machine of a register machine network and a computer program executed therein, according to an embodiment, are explained in detail below with reference to the drawings. The embodiment explained below provides an example of the register machine and the computer program and does not limit the configurations, the specifications, and the like of other embodiments. In the embodiment described below, an accounting apparatus of a semi-self-service checkout system provided in a store such as a supermarket is provided as an example of the register machine.

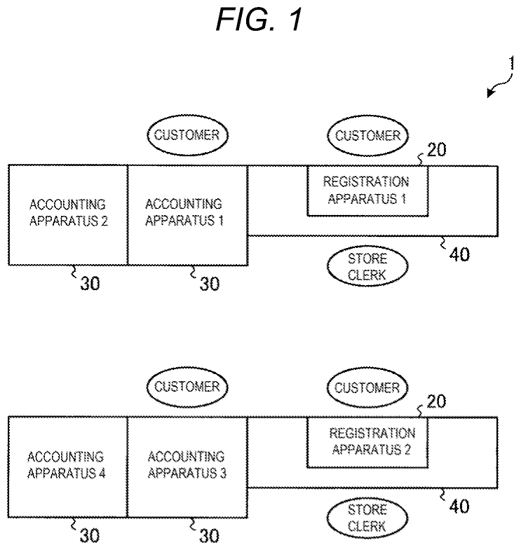

FIG. 1 is a schematic diagram showing an example of a semi-self-service checkout system 1 according to the embodiment. As shown in FIG. 1, the semi-self-service checkout system 1 includes registration apparatuses 20 and accounting apparatuses 30. The registration apparatuses 20 and the accounting apparatuses 30 are connected via a network such as a wired or wireless LAN (Local Area Network). The registration apparatuses 20 are used by store clerks to perform sales registration of sales target commodities and the like. That is, the registration apparatuses 20 generate sales registration information corresponding to commodities sold to customers. The accounting apparatuses 30 are used by the customers to personally execute accounting processing with respect to the commodities for which the sales registration is performed. That is, the accounting apparatuses 30 execute the accounting processing on the basis of the sales registration information transmitted from the registration apparatuses 20. Each accounting apparatus 30 is an example of a checkout device according to the embodiment.

In the semi-self-service checkout system 1 shown in FIG. 1, two accounting apparatuses 30 are associated with one registration apparatus 20. The registration apparatus 20 is provided on a work table 40 having an elongated shape. The two accounting apparatuses 30 are provided adjacent to the work table 40 on which the associated registration apparatus 20 is set. Note that the positions of the registration apparatus 20 and the accounting apparatuses 30 shown in FIG. 1 are an example. The apparatuses may be arranged in other positions. In the example illustrated in FIG. 1, the semi-self-service checkout system 1 includes two registration apparatuses 20 and four accounting apparatuses 30. However, the semi-self-service checkout system 1 may include one or more registration apparatuses 20 and two or more accounting apparatuses 30. Two or more accounting apparatuses 30 may be associated with each registration apparatus 20. Further, the registration apparatus 20 and the accounting apparatuses 30 do not have to be associated.

A customer selects purchase target commodities from commodities displayed in a selling area and collects the purchase target commodities in a shopping basket or the like. The customer carries the commodities collected in the shopping basket or the like to the registration apparatus 20. A store clerk executes, with the registration apparatus 20, sales registration of the commodities collected in the shopping basket or the like. If the sales registration is completed, the store clerk transmits, to the accounting apparatus 30, sales registration information corresponding to the registered commodities. The store clerk directs the customer to the accounting apparatus 30 to which the sales registration information is transmitted. The customer executes the accounting processing in the accounting apparatus 30 to which the customer is directed by the store clerk.

The exteriors of each registration apparatus 20 and accounting apparatus 30 are now explained.

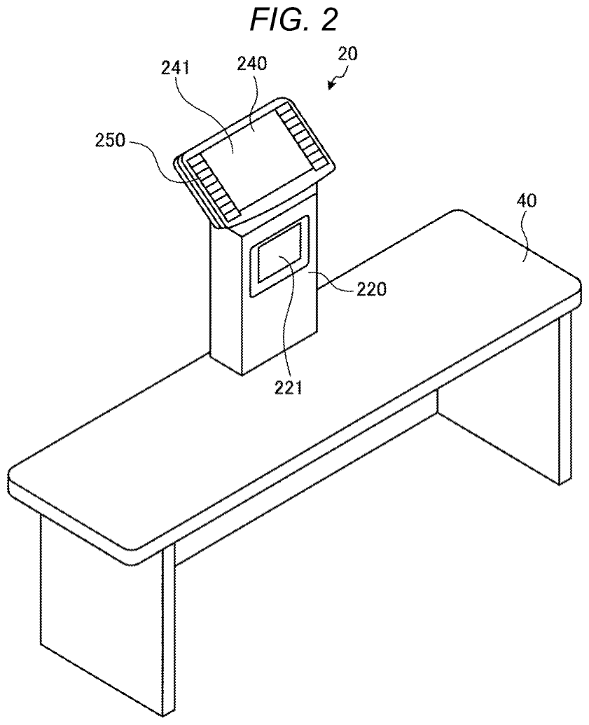

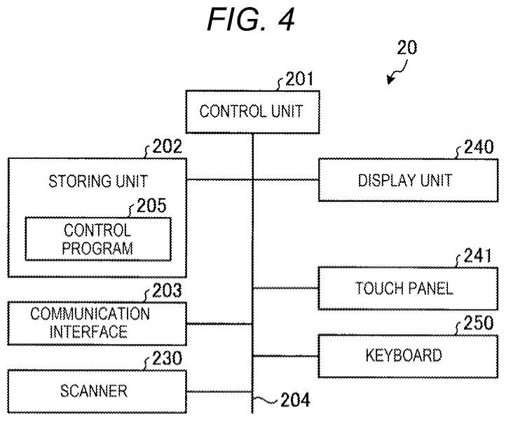

FIG. 2 is a perspective view showing an example exterior of the registration apparatus 20. The registration apparatus 20 is positioned on the upper surface of the work table 40. The registration apparatus 20 is enclosed by a housing 220 having a rectangular shape. The housing 220 includes a reading window 221 on the front surface. The registration apparatus 20 also includes a scanner 230 (see FIG. 4) inside of the reading window 221.

The scanner 230 is a device that reads, from a symbol code attached to a commodity, a commodity code or the like capable of identifying the commodity. The reading window 221 transmits laser light irradiated by the scanner 230 to the outside of the housing 220. Further, the reading window 221 transmits reflected light of the laser light irradiated on the commodity code or the like attached to the commodity to the inside of the housing 220. The scanner 230 reads the commodity code or the like by receiving the reflected light transmitted to the inside of the housing 220. Alternatively, the scanner 230 may generate an image of the commodity and read the commodity code or the like from the generated image.

The registration apparatus 20 includes a display unit 240 positioned above the housing 220. The display unit 240 is a liquid crystal display device that displays various kinds of information such as a name and a price of the commodity read by the scanner 230. The display unit 240 includes a touch panel 241 that receives input of various kinds of operations. Further, the registration apparatus 20 includes a keyboard 250 that also receives input of various kinds of operations.

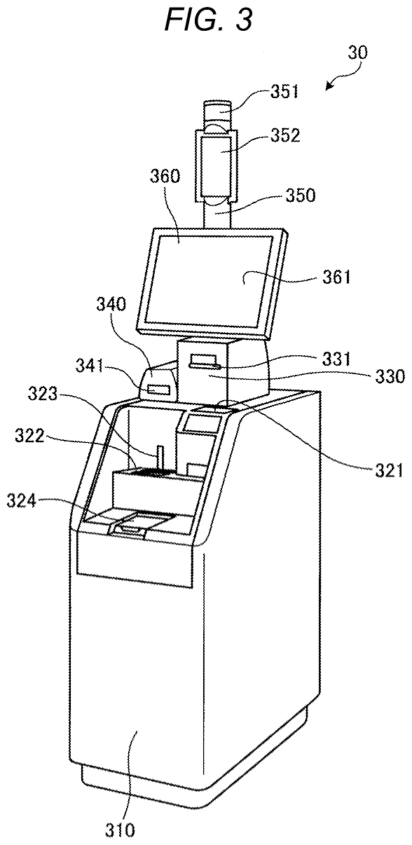

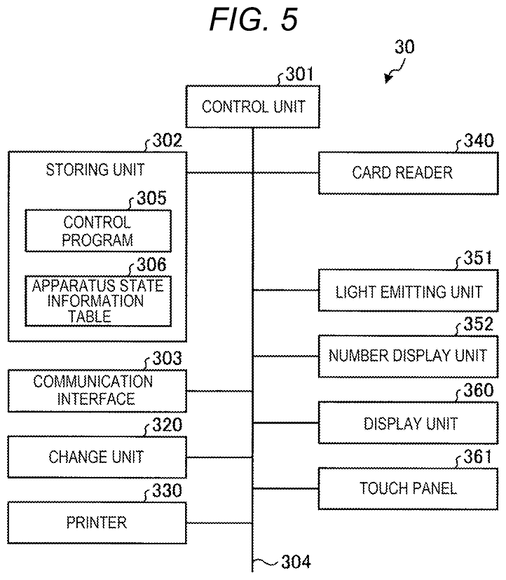

FIG. 3 is a perspective view showing an example exterior of the accounting apparatus 30. The accounting apparatus 30 includes a change unit 320 (see FIG. 5) inside of a housing 310. The accounting apparatus 30 also includes a printer 330, a card reader 340, and a display pole 350 on the upper surface of the housing 310. The accounting apparatus 30 also includes a display unit 360 on the upper surface of the printer 330.

The change unit 320 is a change machine that stores coins and bills inserted by the customer, and dispenses change. The change unit 320 includes a coin insertion port 321, a bill insertion port 322, a bill dispensing port 323, and a coin dispensing port 324. The change unit 320 stores bills inserted into the bill insertion port 322. The change unit 320 also stores coins inserted into the coin insertion port 321. The change unit 320 also dispenses change in the form of bills from the bill dispensing port 323. The change unit 320 dispenses change in the form of coins from the coin dispensing port 324.

The printer 330 includes a receipt port 331. The printer 330 issues, from the receipt port 331, a receipt on which various kinds of information related to one transaction are printed.

The card reader 340 is positioned on the left side of the printer 330 and on the upper surface of the housing 310. The card reader 340 read and writes information from a credit card or the like inserted into a card insertion port 341.

The accounting apparatus 30 includes the display pole 350 on the rear side of the upper surface of the housing 310. The display pole 350 includes, at the top portion, a light emitting unit 351 that emits light having a color corresponding to a present state of the accounting apparatus 30. The display pole 350 includes a number display unit 352 below the light emitting unit 351. The number display unit 352 is a liquid crystal display device that displays an accounting apparatus code for identifying the accounting apparatus 30.

The display unit 360 is a liquid crystal display device that displays, as images or characters, information concerning an operation state of the accounting apparatus 30. The display unit 360 includes a touch panel 361 that receives input of various kinds of operations. The touch panel 361 is an example of an input device according to the embodiment.

FIG. 4 is a block diagram showing an example hardware configuration of the registration apparatus 20. The registration apparatus 20 includes a control unit 201, a storing unit 202, a communication interface 203, the scanner 230, the display unit 240, the touch panel 241, and the keyboard 250. The control unit 201, the storing unit 202, the communication interface 203, the scanner 230, the display unit 240, the touch panel 241, and the keyboard 250 are connected to one another via a system bus 204 such as a data bus or an address bus.

The control unit 201 is a computer that controls the operation of the entire registration apparatus 20 and realizes various functions of the registration apparatus 20. The control unit 201 includes a CPU (Central Processing Unit), a ROM (Read Only Memory), and a RAM (Random Access Memory). The CPU collectively controls the operation of the registration apparatus 20. The ROM is a storage medium that stores various computer programs and data. The RAM is a storage medium that temporarily stores various computer programs and rewritably stores various data. The CPU executes the computer programs stored in the ROM, the storing unit 202, or the like using the RAM as a work area.

The storing unit 202 is a storage device such as a HDD (hard Disk Drive) or a SSD (Solid State Drive). The storing unit 202 stores a control program 205. The control program 205 is a computer program for realizing the functions of the registration apparatus 20 according to the embodiment.

The communication interface 203 is an interface for communicating with the accounting apparatus 30 and the like via a network.

FIG. 5 is a block diagram showing an example hardware configuration of the accounting apparatus 30. The accounting apparatus 30 includes a control unit 301, a storing unit 302, a communication interface 303, the change unit 320, the printer 330, the card reader 340, the light emitting unit 351, the number display unit 352, the display unit 360, and the touch panel 361. The control unit 301, the storing unit 302, the communication interface 303, the change unit 320, the printer 330, the card reader 340, the light emitting unit 351, the number display unit 352, the display unit 360, and the touch panel 361 are connected to one another via a system bus 304 such as a data bus or an address bus.

The control unit 301 is a computer that controls the operation of the entire accounting apparatus 30 and realizes various functions of the accounting apparatus 30. The control unit 301 includes a CPU, a ROM, and a RAM. The CPU collectively controls the operation of the accounting apparatus 30. The ROM is a storage medium that stores various computer programs and data. The RAM is a storage medium that temporarily stores various computer programs and rewritably stores various data. The CPU executes the computer programs stored in the ROM, the storing unit 302, or the like using the RAM as a work area.

The storing unit 302 is a storage device such as a HDD or an SSD. The storing unit 302 stores a control program 305 and an apparatus state information table 306. The control program 305 is a computer program for realizing the functions of the accounting apparatus 30 according to the embodiment.

The apparatus state information table 306 is an information table that stores apparatus state information indicating states of the apparatuses included in the semi-self-checkout system 1. The apparatus state information table 306 stores, as the apparatus state information, for each of the apparatuses, an apparatus code, a type, and state information in association with one another. The apparatus code is identification information for identifying the apparatus. The type is information indicating a type of the apparatus. For example, the type is information indicating that the associated apparatus is the registration apparatus 20 or the accounting apparatus 30. The state information is information indicating a state of the apparatus. For example, the state information indicates states such as not in use, in use, store clerk calling, and a failure state.

The communication interface 303 is an interface for communicating with the registration apparatus 20 and the like via the network.

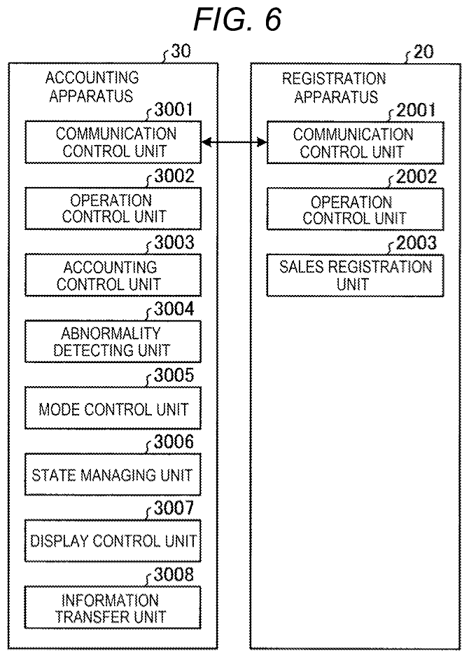

Various functions of the apparatuses of the semi-self-service checkout system 1 are explained. FIG. 6 is a block diagram showing an example functional configuration of the apparatuses of the semi-self-service checkout system 1.

The control unit 201 of the registration apparatus 20 runs, using the RAM and system bus 204, the control program 205 stored in the storing unit 202 and operates according to the control program 205 to generate functional units in the RAM. Specifically, the control unit 201 of the registration apparatus 20 functions as a communication control unit 2001, an operation control unit 2002, and a sales registration unit 2003 as the functional units. That is, in one embodiment, the control unit 201 is a processor that is programmed to carry out the functions of the communication control unit 2001, the operation control unit 2002, and the sales registration unit 2003. In another embodiment, the control unit 201 is a hardware controller, e.g., an application specific integrated circuit (ASIC) and field programmable gate array (FPGA), that is configured to carry out the functions of the communication control unit 2001, the operation control unit 2002, and the sales registration unit 2003.

The communication control unit 2001 controls the communication interface 203 and controls communication with the accounting apparatus 30 and the like.

The operation control unit 2002 receives operation inputs from the touch panel 241 and the keyboard 250. For example, the operation control unit 2002 receives, for example, an operation input for registering a commodity.

The sales registration unit 2003 controls sales registration for registering a commodity being sold to the customer. For example, the sales registration unit 2003 performs sales registration with respect to a commodity having a commodity code read from a code symbol by the scanner 230. The sales registration unit 2003 performs sales registration of a commodity specified by the operation received by the operation control unit 2002. When the operation control unit 2002 receives an operation for ending the sales registration, the sales registration unit 2003 generates sales registration information. That is, the sales registration unit 2003 allocates a transaction code and generates sales registration information including commodity information and price information. The transaction code is identification information for identifying a transaction. The commodity information is information corresponding to a commodity for which sales registration is performed. The commodity information includes information such as a commodity name, a commodity code, and a unit price. The price information is information indicating a total amount and the like of the transaction. The sales registration unit 2003 causes the communication control unit 2001 to transmit the generated sales registration information.

The control unit 301 of the accounting apparatus 30 runs, using the RAM and the system bus 304, the control program 305 stored in the storing unit 302 and operates according to the control program 305 to generate functional units in the RAM. Specifically, the control unit 301 of the accounting apparatus 30 functions as a communication control unit 3001, an operation control unit 3002, an accounting control unit 3003, an abnormality detecting unit 3004, a mode control unit 3005, a state managing unit 3006, a display control unit 3007, and an information transfer unit 3008 as the functional units. That is, in one embodiment, the control unit 301 is a processor that is programmed to carry out the functions of the communication control unit 3001, the operation control unit 3002, the accounting control unit 3003, the abnormality detecting unit 3004, the mode control unit 3005, the state managing unit 3006, the display control unit 3007, and the information transfer unit 3008. In another embodiment, the control unit 301 is a hardware controller, e.g., an application specific integrated circuit (ASIC) and field programmable gate array (FPGA), that is configured to carry out the functions of the communication control unit 3001, the operation control unit 3002, the accounting control unit 3003, the abnormality detecting unit 3004, the mode control unit 3005, the state managing unit 3006, the display control unit 3007, and the information transfer unit 3008.

The communication control unit 3001 is an example of the receiving unit. For example, the communication control unit 3001 controls the communication interface 303 and controls communication with the registration apparatus 20, the other accounting apparatuses 30, and the like. For example, the communication control unit 3001 receives sales registration information from the registration apparatus 20.

The operation control unit 3002 receives operation inputs from the touch panel 361.

The accounting control unit 3003 is an example of the accounting control unit. The accounting control unit 3003 controls execution of accounting processing of a purchase target commodity on the basis of the sales registration information received by the communication control unit 3001. For example, when the communication control unit 3001 receives the sales registration information, the accounting control unit 3003 executes the accounting processing on the basis of the sales registration information. The accounting control unit 3003 displays a total amount of commodities and the like on the display unit 360 and requests payment from the customer. If the payment is made by cash, the accounting control unit 3003 causes the change unit 320 to store the paid cash. If there is change, the accounting control unit 3003 causes the change unit 320 to discharge the change.

The abnormality detecting unit 3004 is an example of a detecting unit. The abnormality detecting unit 3004 detects an abnormality such as a failure that occurs in the accounting apparatus 30. For example, the abnormality detecting unit 3004 detects an abnormality concerning storage amounts of coins and bills stored in the change unit 320. That is, the abnormality detecting unit 3004 detects that the coins and the bills stored in the change unit 320 run short or that the change unit 320 is full of coins and/or bills. The abnormality detecting unit 3004 also detects that the change unit 320 is jammed by a coin or a bill. The abnormality detecting unit 3004 detects that paper of the printer 330 runs short.

The mode control unit 3005 controls modes of the accounting apparatus 30. The modes of the accounting apparatus 30 include a customer mode and a store clerk mode. The customer mode is a mode in which the customer executes the accounting processing. The store clerk mode is a mode in which the store clerk operates the accounting device 30. That is, the store clerk mode is a mode set when the store clerk performs maintenance or the like of the accounting apparatus 30. The mode control unit 3005 changes the mode to the store clerk mode from the customer mode based on a condition that information indicating that the store clerk has authority to shift to the store clerk mode is input. The information indicating that the store clerk has the authority to shift to the store clerk mode is, for example, a store clerk code and a password that identifies the store clerk. The mode control unit 3005 sets the mode of the accounting apparatus 30 to the customer mode based on a condition that the operation control unit 3002 receives an operation for setting the accounting apparatus 30 to the customer mode.

The state managing unit 3006 manages states of the apparatuses of the semi-self-service checkout system 1. For example, if the communication control unit 3001 receives apparatus state information from each of the accounting apparatuses 30 of the semi-self-service checkout system 1, the state managing unit 3006 stores the apparatus state information in the apparatus state information table 306. Every time a predetermined time elapses or every time a state of the accounting apparatus 30 changes, the state managing unit 3006 causes the communication control unit 3001 to transmit the apparatus state information indicating the state of the accounting apparatus 30 to the other accounting apparatuses 30.

The display control unit 3007 is an example of the display control unit. The display control unit 3007 causes the display unit 360 to display various screens. For example, when the abnormality detecting unit 3004 detects abnormality, the display control unit 3007 causes the display unit 360 to display a calling screen indicating that the store clerk is being called. The display control unit 3007 causes the display unit 360 to display a transfer confirmation screen 3100 when the store clerk code or the like is input on the calling screen and the accounting apparatus 30 is set to the store clerk mode.

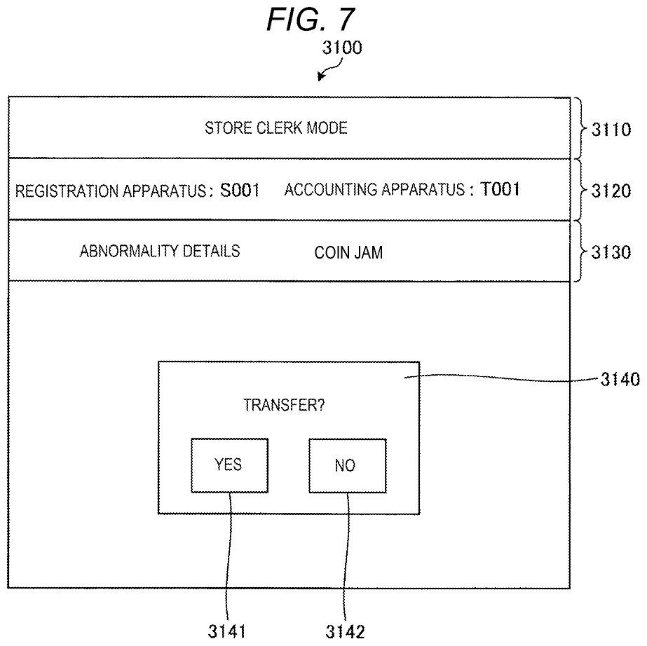

FIG. 7 is a diagram showing an example of the transfer confirmation screen 3100. The transfer confirmation screen 3100 is a screen for confirming whether to transfer sales registration information. The transfer confirmation screen 3100 includes a mode display region 3110, an apparatus display region 3120, an abnormality display region 3130, and a transfer confirmation region 3140. The mode display region 3110 is a region indicating a present mode. The apparatus display region 3120 is a region for displaying an identification of the accounting apparatus 30 and the registration apparatus 20 that transmits sales registration information used for the accounting processing currently being executed. The abnormality display region 3130 is a region for displaying abnormality detected by the abnormality detecting unit 3004. The store clerk determines, according to details of the abnormality displayed in the abnormality display region 3130, whether the sales registration information should be transferred in order to execute the accounting processing in the other accounting apparatuses 30 or whether the abnormality of the accounting apparatus 30 should be solved. The transfer confirmation region 3140 is a region for inputting whether the sales registration information is transferred.

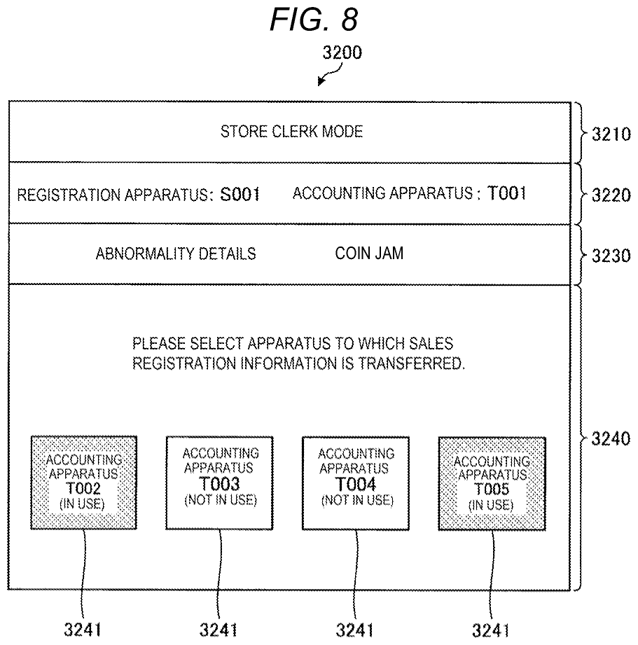

The transfer confirmation region 3140 includes a YES button 3141 and a NO button 3142. The YES button 3141 is a button for inputting operation to indicate that the sales registration information is transferred. That is, the YES button 3141 is a button for displaying an apparatus selection screen 3200 (see FIG. 8). The NO button 3142 is a button for inputting operation to indicate that the sales registration information is not transferred. That is, the NO button 3142 is a button pressed if, even if an abnormality occurs in the accounting apparatus 30, the abnormality of the accounting apparatus 30 is resolved and the accounting processing is to be performed in the accounting apparatus 30. For example, if the change unit 320 is jammed by a coin or the like before a total amount input by the customer is identified, since a change amount or the like that should be refunded to the customer is unknown, the store clerk should resolve the abnormality of the accounting apparatus 30. In such a case, the NO button 3142 is pressed. In this way, the abnormality of the accounting apparatus 30 should be resolved in some cases. If the decision concerning whether the sales registration information is transferred is left to the customer, it is likely that an unexpected trouble occurs. Therefore, the display control unit 3007 causes the display unit 360 to display the transfer confirmation screen 3100 only after the store clerk code is input.

FIG. 8 is a diagram showing an example of the apparatus selection screen 3200. The apparatus selection screen 3200 is a screen for allowing the customer to select, instead of the current accounting apparatus 30, an alternative apparatus that executes the accounting processing. The alternative apparatus is, for example, a different accounting apparatus 30. The display control unit 3007 causes the display unit 360 to display the apparatus selection screen 3200 when the accounting apparatus 30 is in the store clerk mode. That is, the display control unit 3007 causes the display unit 360 to display the apparatus selection screen 3200 when the store clerk code is input as information indicating that the store clerk has the shift authority.

The apparatus selection screen 3200 includes a mode display region 3210, an apparatus display region 3220, an abnormality display region 3230, and an apparatus selection region 3240. The mode display region 3210, the apparatus display region 3220, and the abnormality display region 3230 are regions for displaying the same contents as the contents displayed in the mode display region 3110, the apparatus display region 3120, and the abnormality display region 3130 of the transfer confirmation screen 3100. The apparatus selection region 3240 is a region in which an apparatus selection button 3241 for selecting an alternative apparatus is displayed.

The display control unit 3007 displays, on the basis of the apparatus state information table 306, one or more apparatus selection buttons 3241 for selecting an alternative apparatus. The apparatus selection button 3241 includes a type of an apparatus, an apparatus code capable of identifying the apparatus, and state information indicating a state of the apparatus. The display control unit 3007 causes the display unit 360 to display the apparatus selection button 3241 so as distinguish the accounting apparatus 30 capable of executing the accounting processing from the accounting apparatus 30 incapable of executing the accounting processing. That is, the display control unit 3007 grays out, on the basis of the state information of the apparatuses stored in the apparatus state information table 306, the accounting apparatus 30 that cannot execute the accounting processing because, for example, the accounting apparatus 30 is in use. In the case that the accounting apparatus 30 is not in use or the like, the display control unit 3007 determines that the accounting processing is executable. On the other hand, in the case that the accounting apparatus is in use, store clerk has been called, a failure mode, or the like, the display control unit 3007 determines that the accounting processing is unexecutable. In the apparatus selection screen 3200 shown in FIG. 8, “T002” and “T005” are grayed-out as the un-selectable accounting apparatuses 30. Note that a method of displaying un-selectable accounting apparatuses 30 is not limited to being grayed-out. For example, the display control unit 3007 may clearly indicate with characters, figures, or the like that certain accounting apparatuses 30 are un-selectable or may not display the apparatus selection buttons 3241 of the un-selectable accounting apparatuses 30.

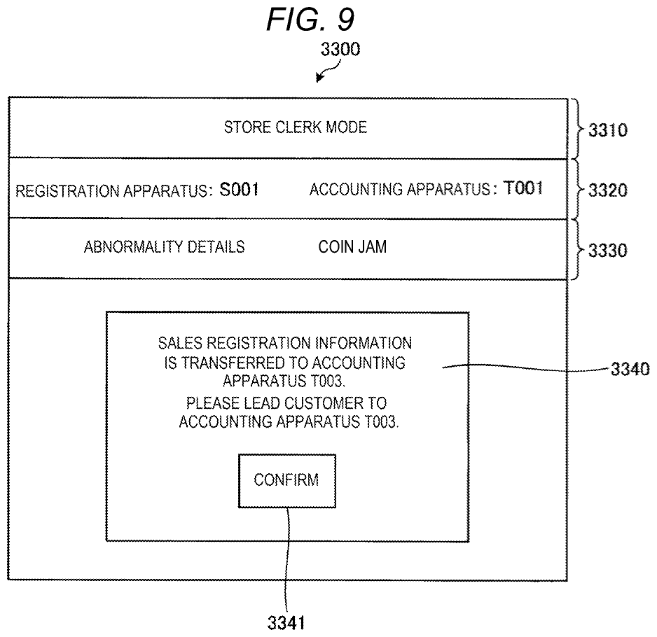

FIG. 9 is a diagram showing an example of the transfer completion screen 3300. The transfer completion screen 3300 is a screen for displaying completion of transfer of sales registration information to an apparatus selected by the apparatus selection button 3241 in the apparatus selection screen 3200. The transfer completion screen 3300 includes a mode display region 3310, an apparatus display region 3320, an abnormality display region 3330, and a completion display region 3340. The mode display region 3310, the apparatus display region 3320, and the abnormality display region 3330 are regions for displaying the same contents as the contents of the mode display region 3110, the apparatus display region 3120, and the abnormality display region 3130 of the transfer confirmation screen 3100. The completion display region 3340 is a region for displaying the completion of the transfer of the sales registration information. The accounting apparatus 30 that transfers the sales registration information is displayed in the completion display region 3340. Further, a confirmation button 3341 is displayed in the completion display region 3340. The confirmation button 3341 is a button for inputting confirmation of the accounting apparatus 30 at a transfer destination to which the sales registration information is transferred.

The information transfer unit 3008 is an example of the changing unit and the transmitting unit. The information transfer unit 3008 designates, as an alternative apparatus, the accounting apparatus 30 selected in the apparatus selection screen 3200. That is, the information transfer unit 3008 changes the accounting apparatus 30 that executes the accounting processing to the alternative apparatus selected on the apparatus selection screen 3200. The information transfer unit 3008 causes, on the basis of a result of the designation, the communication control unit 3001 to transmit the sales registration information. That is, the information transfer unit 3008 transmits, in cooperation with the communication control unit 3001, the sales registration information to the designated accounting apparatus 30.

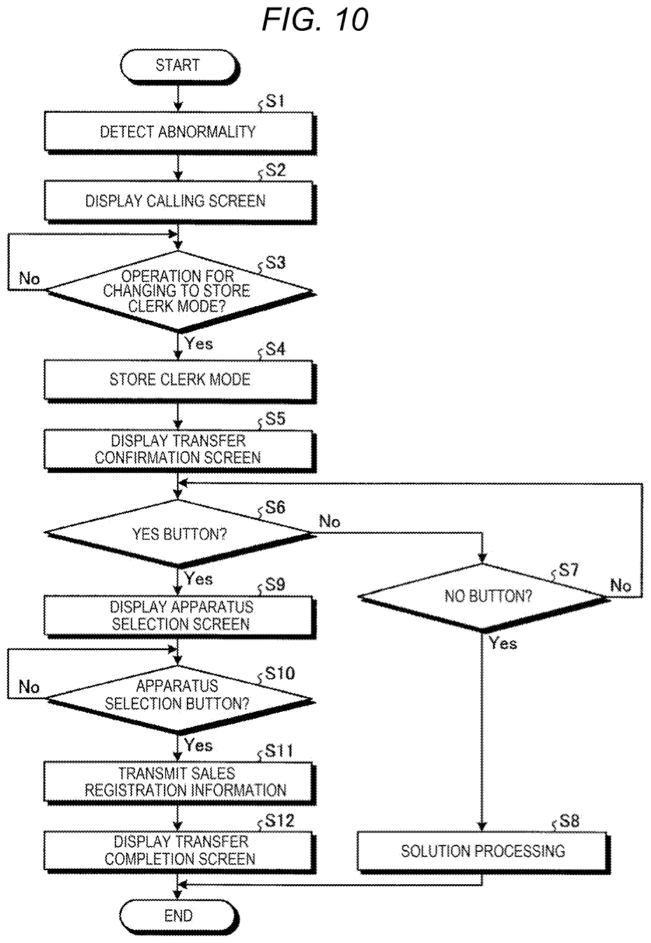

Transfer processing executed by the accounting apparatus 30 is explained. FIG. 10 is a flowchart illustrating an example of the transfer processing executed by the accounting apparatus 30 according to the embodiment.

The abnormality detecting unit 3004 detects an abnormality (Act S1). The display control unit 3007 causes the display unit 360 to display a calling screen indicating that the store clerk is being called (Act S2). The operation control unit 3002 stays on standby until an operation for changing the mode of the accounting apparatus 30 to the store clerk mode is received (No in Act S3).

On the other hand, when the operation for changing the mode of the accounting apparatus 30 to the store clerk mode is received (Yes in Act S3), the mode control unit 3005 shifts the accounting apparatus 30 to the store clerk mode (Act S4). The display control unit 3007 causes the display unit 360 to display the transfer confirmation screen 3100 (Act S5).

When the YES button 3141 of the transfer confirmation screen 3100 is not pressed (No in Act S6) and the NO button 3142 is not pressed (No in Act S7), the operation control unit 3002 returns to Act S6. On the other hand, when the pressing of the NO button 3142 is received (Yes in Act S7), the accounting apparatus 30 receives solution processing for solving detected abnormality (Act S8).

On the other hand, when the pressing of the YES button 3141 is received (Yes in Act S6), the display control unit 3007 causes the display unit 360 to display the apparatus selection screen 3200 (Act S9). The operation control unit 3002 determines whether pressing of the apparatus selection button 3241 on the apparatus selection screen 3200 is received (Act S10). The accounting apparatus 30 waits until the pressing of the apparatus selection button 3241 is received (No in Act S10).

When the pressing of the apparatus selection button 3241 is received (Yes in Act S10), the communication control unit 3001 transmits sales registration information to an apparatus indicated by the pressed apparatus selection button 3241 (Act S11). The display control unit 3007 causes the display unit 360 to display the transfer completion screen 3300 (Act S12).

Consequently, the accounting apparatus 30 ends the transfer processing.

As explained above, with the semi-self-service checkout system 1 according to the embodiment, if an abnormality such as a failure occurs in the accounting apparatus 30, the accounting apparatus 30 causes the display unit 360 to display the apparatus selection screen 3200 for causing the customer to select an alternative apparatus to execute the accounting processing. The accounting apparatus 30 designates, as the alternative apparatus, the accounting apparatus 30 selected on the apparatus selection screen 3200. The accounting apparatus 30 transmits the sales registration information to the designated accounting apparatus 30. Consequently, the store clerk directs the customer to the designated accounting apparatus 30. Therefore, the customer can perform the accounting processing in the new accounting apparatus 30 without waiting for the work to resolving the abnormality or the like that occurs in the accounting apparatus 30. Therefore, the accounting apparatus 30 according to the embodiment can improve convenience of the customer.

The embodiment is explained above. However, the embodiment is presented as an example and is not intended to limit the scope of the invention. The new embodiment can be implemented in other various forms. Various omissions, replacements, and changes of the embodiment can be performed without departing from the spirit of the invention. The embodiment and modifications of the embodiment are included in the scope and the gist of the invention and included in the inventions described in claims and the scope of equivalents of the inventions.

In the embodiment, it is explained that the alternative apparatus is, for example, another accounting apparatus 30. However, the alternative apparatus is not limited to another accounting apparatus 30. For example, the apparatus that executes the accounting processing may be a POS (Point of Sales) terminal or the like instead of the accounting apparatus 30. In this case, the display control unit 3007 causes the display unit 360 to display an apparatus capable of executing the accounting processing on the apparatus selection screen 3200. The information transfer unit 3008 causes the communication control unit 3001 to transmit the sales registration information to the apparatus selected on the apparatus selection screen 3200.

In the embodiment, the information transfer unit 3008 transmits the sales registration information to the designated accounting apparatus 30 in cooperation with the communication control unit 3001. However, the information transfer unit 3008 may transmit the sales registration information to the designated accounting apparatus 30 via another apparatus such as a store server or the registration apparatus 20. Further, if the sales registration information is stored in the other apparatus such as the store server or the registration apparatus 20, the information transfer unit 3008 may not transmit the sales registration information. In this case, the information transfer unit 3008 notifies the designated accounting apparatus 30 of the other apparatus in which the sales registration information is stored such as the store server or the registration apparatus 20. The other apparatus in which the sales registration information is stored may transmit the sales registration information to the designated accounting apparatus 30.

In the embodiment, the example is explained in which the checkout system includes the accounting apparatus 30. However, the checkout system can also include apparatuses other than the accounting apparatus 30. For example, the checkout system can include a server apparatus and a client apparatus. In this case, the server apparatus is, for example, an apparatus such as a personal computer or a cloud service for providing computer resources such as hardware and software. The client apparatus may be, for example, an apparatus that exclusively executes the accounting processing or may be a general-purpose apparatus such as a tablet terminal. In this case, the server apparatus receives the sales registration information from the registration apparatus 20. The server apparatus generates, according to a request from the client apparatus, screen information for causing the client apparatus to display various screens such as the calling screen, the apparatus selection screen 3200, the transfer confirmation screen 3100, and the transfer completion screen 3300. The server apparatus transmits the screen information to the client apparatus. Consequently, the server apparatus can designate, as the alternative apparatus, another client apparatus selected on the apparatus selection screen 3200 displayed by the client apparatus. That is, the server apparatus can change, to the alternative apparatus, an alternative apparatus to execute the accounting processing. The client apparatus designated as the alternative apparatus can execute the accounting processing.

The checkout system may be applied to an attendant apparatus that displays states of the accounting apparatuses 30 set in the store. The attendant apparatus may be a POS terminal, may be a personal computer, or may be a tablet terminal. In this case, if an abnormality of the accounting apparatus 30 is detected, the attendant apparatus causes the display unit 360 to display the apparatus selection screen 3200. Further, the attendant apparatus causes, according to received operation, the display unit 360 to display the transfer confirmation screen 3100 or the transfer completion screen 3300. Consequently, the attendant apparatus can designate, as the alternative apparatus, the accounting apparatus 30 selected on the apparatus selection screen 3200. That is, the attendant apparatus can change, to the alternative apparatus, an apparatus that executes the accounting processing. The accounting apparatus 30 designated as the alternative apparatus can execute the accounting processing.

The computer programs executed by the apparatuses in the embodiment and the modifications are provided while being incorporated in advance in storage media (ROMs or storing units) included in the apparatuses. However, the computer programs are not limited to this. For example, the computer programs may be provided while being recorded in a computer-readable recording medium such as a CD-ROM, a flexible disk (FD), a CD-R, or a DVD (Digital Versatile Disk) as a file of an installable format or an executable format. Further, the storage media are not limited to media independent from a computer or an incorporated system and include storage media in which the computer programs transmitted by a LAN, the Internet, or the like are downloaded and stored or temporarily stored.

The computer programs executed by the apparatuses in the embodiment and the modifications may be stored on a computer connected to a network such as the Internet and may be provided by being downloaded through the network or may be provided or distributed through the network such as the Internet.

What is claimed is:

1. A checkout machine comprising:
a network interface connectable to a network and configured to receive product registration data from a registration machine via the network;
a card reader;
a cash processing device configured to perform at least one of receiving and disposing of cash;
a printer;
a display; and
a controller configured to:
perform a checkout operation based on the received product registration data and payment made through one of the card reader and the cash processing device;
detect an abnormality on one or more of the card reader, the cash processing device, and the printer during the checkout operation; and
when the abnormality being detected, control the display device to display a selection screen to select a substitute checkout machine connected to the network and control the network interface to transmit the product registration data to the selected substitute checkout machine.

2. The checkout machine according to claim 1, wherein the selection screen includes a selectable object corresponding to an available checkout machine and a non-selectable object corresponding to an unavailable checkout machine.

3. The checkout machine according to claim 1, wherein the selection screen indicates details of the abnormality.

4. The checkout machine according to claim 1, wherein
the checkout machine is operable in a self-service mode and a store clerk mode, and
the controller is configured to enable display of the screen during the store clerk more and disable display of the screen during the self-service mode.

5. The checkout machine according to claim 4, wherein the selection screen indicates an operation mode of the checkout machine.

6. The checkout machine according to claim 4, wherein the controller is configured to control the display device to display the selection screen after an operation mode of the checkout machine being switched from the self-service mode to the store clerk mode when the abnormality is detected during the self-service mode.

7. The checkout machine according to claim 6, wherein the controller is configured to control the display device to display a confirmation screen to select whether or not to transfer the product registration data after the operation mode being switched from the self-service mode to the store clerk mode when the abnormality is detected during the self-service mode, and display the selection screen when the product registration data is selected to be transferred on the confirmation screen.

8. The checkout machine according to claim 7, wherein the selection screen is not displayed when the product registration data is selected to be not transferred on the confirmation screen.

9. The checkout machine according to claim 7, wherein the confirmation screen indicates details of the abnormality.

10. The checkout machine according to claim 7, wherein the confirmation screen indicates an operation mode of the checkout machine.

11. A checkout system comprising:
a registration machine configured to perform a product registration operation and transmit product registration data generated through the product registration operation over a network; and
a plurality of checkout machines connected to the network, wherein at least one of the checkout machines comprises:
a network interface connectable to the network and configured to receive the product registration data via the network;
a card reader;
a cash processing device configured to perform at least one of receiving and disposing of cash;
a printer;
a display; and
a controller configured to:
perform a checkout operation based on the received product registration data and payment made through one of the card reader and the cash processing device;
detect an abnormality on one or more of the card reader, the cash processing device, and the printer during the checkout operation; and
when the abnormality being detected, control the display device to display a selection screen to select as a substitute checkout machine one of the plurality of checkout machines and control the network interface to transmit the product registration data to the selected substitute checkout machine.

12. The checkout system according to claim 11, wherein the selection screen includes a selectable object corresponding to an available checkout machine and a non-selectable object corresponding to an unavailable checkout machine.

13. The checkout system according to claim 11, wherein the selection screen indicates details of the abnormality.

14. The checkout system according to claim 11, wherein
the at least one of the checkout machines is operable in a self-service mode and a store clerk mode, and
the controller is configured to enable display of the screen during the store clerk more and disable display of the screen during the self-service mode.

15. The checkout system according to claim 14, wherein the selection screen indicates an operation mode of the at least one of the checkout machines.

16. The checkout system according to claim 14, wherein the controller is configured to control the display device to display the selection screen after an operation mode of the at least one of the checkout machines being switched from the self-service mode to the store clerk mode when the abnormality is detected during the self-service mode.

17. The checkout system according to claim 16, wherein the controller is configured to control the display device to display a confirmation screen to select whether or not to transfer the product registration data after the operation mode being switched from the self-service mode to the store clerk mode when the abnormality is detected during the self-service mode, and display the selection screen when the product registration data is selected to be transferred on the confirmation screen.

18. The checkout system according to claim 17, wherein the selection screen is not displayed when the product registration data is selected to be not transferred on the confirmation screen.

19. The checkout system according to claim 17, wherein the confirmation screen indicates details of the abnormality.

20. The checkout system according to claim 17, wherein the confirmation screen indicates an operation mode of the at least one of the checkout machines.
